(19) United States
(12) Patent Application Publication
(10) Pub. No.: US 2026/0148131 A1
(43) Pub. Date: May 28, 2026

(54) System and method for sharing resources in a computing network

(71) Applicant: Bank of America Corporation, Charlotte, NC (US)

(72) Inventors: Jemlin Lucas, Coppell, TX (US); Suryanarayana Adivi, Hyderabad (IN); Sujatha Ambati, Hyderabad (IN); Niroop Reddy Patimeedi, Hyderabad (IN); Pushkar Taneja, Hyderabad (IN)

(21) Appl. No.: 18/962,416

(22) Filed: Nov. 27, 2024

(51) Int. Cl. G06N 20/00; G06N 5/02

(52) U.S. Cl. CPC G06N 20/00; G06N 5/02

(57) ABSTRACT

In response to receiving a request from a first computing node of a computing network for a first piece of data, the request is input to an Artificial Intelligence (AI) model. The AI model is trained using a knowledge graph and one or more data transfer constraints to determine a second computing node of the computing network that stores the requested first piece of data. In response to receiving an identity of the second computing node that stores the requested piece of data as a result of the AI model, a transfer is initiated of the first piece of data from the second computing node to the first computing node.

### TECHNICAL FELD

The present disclosure relates generally to network communication, and more specifically to a system and method for sharing resources in a computing network.

### BACKGROUND

A computing node of a computing network often needs to access and download data stored at other computing nodes of the computing network to provide a requested service. Consumption of data across computing nodes of a computing network is often associated with high network latency, unnecessary data redundancy and under-utilization of computing resources resulting in reduced computing system performance and network performance.

### SUMMARY

The system disclosed in the present disclosure provides technical solutions to the technical problems discussed above by providing improved techniques to make requested data available to computing nodes while avoiding the inefficiencies of the conventional systems.

A computing node of a computing infrastructure often needs to access and download data stored at other computing nodes of the computing infrastructure to provide a requested service. For example, a first data server that is configured to generate employee reports upon request of a user may need to access employee data stored at one or more other data servers. In conventional systems, consumption of data across computing nodes of a computing network is often associated with several inefficiencies. For example, in conventional systems transfer of data resources across computing nodes of a computing infrastructure causes unnecessary data redundancy where multiple computing nodes end up storing the same data. For example, regional employee data records of an organization's employees are typically stored in respective regional data servers that are physically located in respective regions. For example, employee records of employees located in the USA are stored in database servers that are physically located in the USA and employee records of employees located in Japan are stored in database servers that are physically located in Japan. Thus, a data server configured to generate employee reports located in a particular region needs to access and download regional employee records from a database server location in that region.

Several delays are generally associated with accessing and downloading data from a computing node. In one example, accessing a data server may involve lengthy authentication and authorization procedures that add delays in procuring the required data. For example, enhanced authentication and authorization procedures may be implemented for data transfers across countries that may cause delays in accessing data across countries. Further, network latencies due to computing nodes located in different locations may introduce delays in procuring the required data. A primary factor influencing network latency associated with a data transfer is the physical distance data packets need to travel between a transmitting node and a receiving node. This means that the further apart the transmitting and receiving nodes are, the longer it takes for data to travel between them, resulting in increased network delay or latency. For example, when the accessing a server that is configured to generate employee reports is in New York and the database server storing employee records needed to generate the report is in Tokyo, the data packets have a longer journey compared to if both were in the same city.

In conventional systems, computing nodes usually download and store data locally (e.g., storing data in a data server located in the same city or state) to avoid lengthy access procedures and network delays. For example, regional employee data records may be downloaded from the respective regional database servers and stored at a data server that is geographically located in the same city as the processing server configured to generate employee reports. However, when multiple computing nodes download the same piece of data from a regional server, this leads to data redundancy where the same data is stored at several computing nodes. This data redundancy leads to wastage of data storage resources that can otherwise be used to store other data. Additionally, storage of sensitive data at multiple computing nodes lowers data security. For example, storing sensitive data across multiple servers can lower data security because it increases the potential attack surface, making it more difficult to manage access controls and monitor activity across all locations, which can lead to vulnerabilities where a breach could occur if proper security measures aren't implemented on each server, especially if the data isn't adequately encrypted across all locations.

The disclosed system and method provide technical solutions to the technical problems discussed above by providing a practical application of making requested data available to computing nodes while avoiding the inefficiencies of the conventional systems. As described in embodiments of the present disclosure, an artificial intelligence (AI) model is trained based on a knowledge graph of at least a portion of a computing infrastructure and one or more data transfer constraints to determine and select a computing node that stores a requested piece of data such that transfer of the requested data from the selected computing node to a requesting computing node satisfies the data transfer constraints. The knowledge graph is a structed way of representing the computing infrastructure or a portion thereof and represents a plurality of computing nodes of the computing infrastructure and data stored at each of the computing nodes as logical nodes and relationships between the logical nodes. Additional attributes or properties are associated with each logical node of the knowledge graph, wherein each attribute associated with a logical node provides information associated with the logical node. For example, attributes associated with a logical node that represents a computing node may include, but are not limited to, a device identity (ID) of the computing node, an Internet Protocol (IP) address of the computing node, a physical address of the computing node, and real-time performance metrics such as processing speed, CPU usage, memory usage, network bandwidth and average response time. The predefined data transfer constraints define desired performance metrics that a computing node selected by the AI model is to adhere to. The data transfer constraints may include, but are not limited to, a maximum network latency associated with transfer for data from a selected computing node to a requesting computing node, a minimum CPU performance associated with the selected computing node, a minimum response time associated with the selected computing node, and a minimum network bandwidth available to the selected computing node.

In response to receiving a data request from a requesting computing node, the transfer manager may be configured to input the data request or at least the requested data included in the data request to the AI model. The trained AI model searches the knowledge graph for a computing node that stores the requested data such that a transfer of the requested data from the computing node to the requesting computing node satisfies one or more predefined data transfer constraints. For example, the AI model selects a computing node that stores the requested data, wherein response time associated with the selected computing node is lower than a predefined maximum response time and an estimated network latency of a data transfer from the selected computing node to the requesting computing node is lower than the predefined network latency. Upon receiving a selection of the computing node from the AI model, a data transfer is initiated from the selected computing node to the requesting computing node.

By implementing data transfers between computing nodes that satisfy predefined data transfer constraints such as maximum network latency and response time, the disclosed system and method avoids or eliminates the need for computing nodes to download and store data locally. This saves memory storage resources at the computing nodes. Further, by implementing transfer of requested data to a requesting computing node that adheres to predefined data transfer constraints, the disclosed system and method avoid processing delays at that requesting computing node that relies on the requested data for completing its processing. This increases CPU response times at the requesting computing node and generally improves processing efficiency and performance of the requesting computing node. Additionally, by avoiding or eliminating the need for computing nodes to download and store data locally, the disclosed system and methods reduce data redundancy. Reduced data redundancy across computing nodes of a computing infrastructure reduces potential attack surface and vulnerabilities thus lowering the possibility of a data breach. Thus, the disclosed system and method improve data security in a computing infrastructure.

Another inefficiency associated with accessing and transferring data across computing nodes of a computing infrastructure in conventional systems includes lengthy data scanning and retrieval leading to decreased computing performance and decreased network performance. For example, in conventional systems, a computing node does not know which computing nodes store what data. Thus, a computing node generally spends large amounts of computing and network resources to scan other computing nodes to determine a particular computing node that stores a requested piece of data. For example, large amounts of computing and network resources may need to be employed to scan all data servers of a particular region for a requested piece of data. This problem is more severe in a large computing infrastructure with thousands of computing nodes connected in a network and can severely compromise performance of computing nodes and the network.

The disclosed system and method provide technical solutions to this technical problem by using an AI model trained based on a knowledge graph of the computing infrastructure to quickly select a suitable computing node for a requested data transfer. This avoids lengthy and time-consuming scanning of the computing infrastructure by computing nodes to retrieve requested data. Avoiding lengthy data scanning and retrieval procedures save computing and network resources such as network bandwidth that would otherwise be used to perform the scanning procedures. By saving computing and network resources, the disclosed system and method improve performance of computing nodes and network performance.

Another inefficiency associated with accessing and transferring data across computing nodes of a computing infrastructure in conventional systems includes underutilization of memory resources due to data redundancy. As described above, in conventional systems, multiple computing nodes may locally store the same piece of data to avoid lengthy access procedures and network delays. For example, multiple processing servers, each configured to generate employee reports, may download employee data records relating to employees located in Japan from a regional database server located in Tokyo. However, it has been seen that most computing nodes rarely use most locally stored pieces of data leading to underutilization of memory resources thus resulting in wastage of memory resources. For example, a processing server configured to generate employee reports may be configured or requested to generate an employee report relating to Japanese employees on a quarterly basis, which means that the employee records relating to the Japanese employees stored locally at the processing server is only used once in three months.

The disclosed system and method provide technical solutions to this technical problem by avoiding data redundancy across computing nodes of a computing infrastructure as described above. For example, as described above, the disclosed system and method avoid local storage of data at computing nodes thus avoiding data redundancy. By avoiding local storage of data, the disclosed system and method free up memory resources that can be used to store other important data including software that can monitor and improve computing performance. Accordingly, the disclosed system and method improve computing performance of the computing nodes.

By avoiding the inefficiencies associated with conventional systems, the disclosed system and method generally improve technology associated with a computing network.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates a flowchart of an example method for transferring data in a computing infrastructure, in accordance with one or more embodiments of the present disclosure.

### DETAILED DESCRIPTION

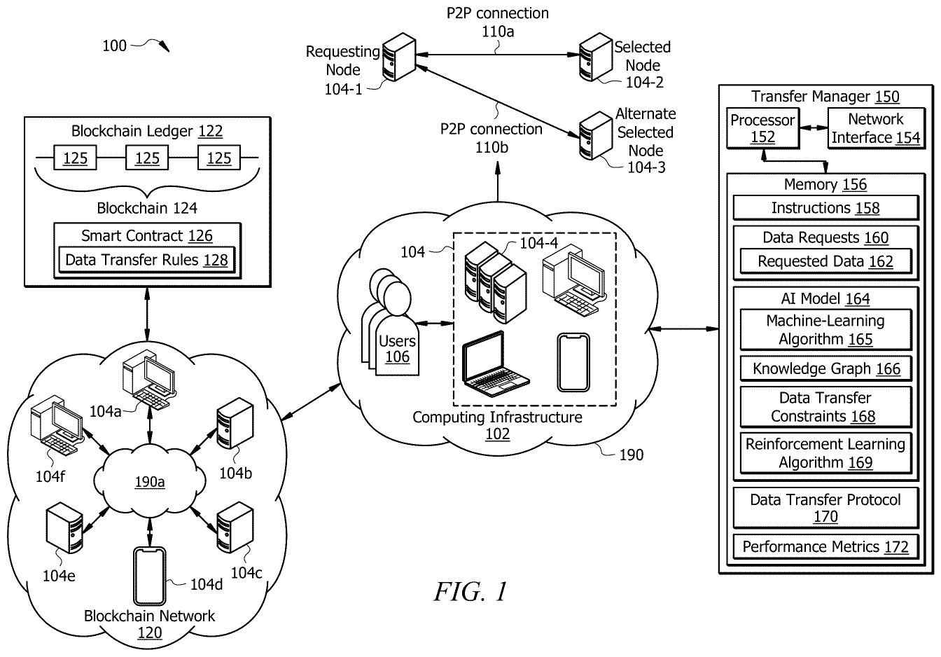

FIG. 1 is a schematic diagram of a system 100, in accordance with certain aspects of the present disclosure. As shown, system 100 includes a computing infrastructure 102 including a plurality of computing nodes 104 connected to a network 190. Computing infrastructure 102 may include a plurality of hardware and software components. The hardware components may include, but are not limited to, computing nodes 104 such as desktop computers, smartphones, tablet computers, laptop computers, servers and data centers, virtual reality (VR) headsets, augmented reality (AR) glasses and other hardware devices such as printers, routers, hubs, switches, and memory devices, that are all connected to the network 190. Software components may include software applications that are run by one or more of the computing nodes 104 including, but not limited to, operating systems, user interface applications, third party software, database management software, service management software, mainframe software, metaverse software, AI tools (e.g., AI/ML model 164) and other customized software programs (e.g., transfer manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the transfer manager 150. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user 106 may be referred to as a user device. For example, a computing node 104 may provide a user interface that may be used by a user 106 to operate the computing node 104 and perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system hosting software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

At least a portion of the computing infrastructure 102 may include a blockchain network 120. For example, a portion of the computing nodes 104 may form the blockchain network 120. As shown in FIG. 1, example blockchain network 120 includes computing nodes 104a, 104b, 104c, 104d, 104e, and 104f connected to each other via a portion of the network 190 (shown as 190a). The blockchain network 120 implements distributed computing which generally refers to a method of making multiple computers (e.g., computing nodes 104a-104f) work together to solve a common problem. This makes a computer network (e.g., blockchain network 120) appear as a powerful single computer that provides large-scale resources to deal with complex challenges. For example, distributed computing can encrypt large volumes of data, solve complex physics and chemical equations with many variables, and render high-quality, three-dimensional video animation. Distributed computing often uses specialized software applications that are configured to run on several computing nodes 104 instead of on just one computer, such that different computers perform different tasks and communicate to develop the final solution. High-performing distributed computing is often used in engineering research, financial services, energy sector and the like to run complex processes.

Blockchain network 120 may implement a blockchain 124 across a plurality of the computing nodes 104 (e.g., computing nodes 104a-104f). A blockchain (e.g., blockchain 124) generally is an open, decentralized and distributed digital ledger (e.g., blockchain ledger 122) consisting of records called blocks that are used to record data interactions across many computing nodes (e.g., computing nodes 104). Each computing node 104 of a blockchain network (e.g., blockchain network 120) may maintain a copy of the blockchain ledger (e.g., blockchain ledger 122). Logically, a blockchain is a chain of blocks which contains specific information. As shown in FIG. 1, blockchain 124 includes a chain of blocks 125. Once recorded, the data in any given block 125 cannot be altered retroactively without alteration of all subsequent blocks 125, which requires consensus of the network majority. Each computing node 104 within the blockchain network 120 maintains, approves, and updates new entries. The system is controlled not only by separate individuals, but by everyone within the blockchain network 120. Each member ensures that all records and procedures are in order, which results in data validity and security. Thus, the distributed ledger 122 can record data interactions between two parties (e.g., a data transfer between two computing nodes 104) efficiently and in a verifiable and permanent way. By design, a blockchain 124 is resistant to modification of the data. In one embodiment, as discussed below in more detail, the blockchain network 120 may store smart contracts 126 (e.g., in the blockchain ledger 122) that implement transfer of data between computing nodes 104 of the computing infrastructure 102.

Any new interaction or activity (e.g., data transfer between computing nodes 104) within the blockchain network or between a computing node of the blockchain network and an external computing node 104 may trigger the building of a new block of the blockchain. An interaction may include a computing node 104 of the blockchain network transmitting or receiving data from another computing node 104 of the blockchain network or from a computing node that is not part of the blockchain network. In the context of the present disclosure, an interaction may include a data transfer between two computing nodes 104, wherein one, both, or none of the two computing nodes 104 are part of the blockchain network 120. Before a new block 125 is added to the blockchain, it needs to be verified by a majority of the computing nodes in the blockchain network 120.

Each block 125 of the blockchain includes a hash of the block 125, a hash of the previous block 125, data that records one or more data interactions or activities associated with the block 125, and a timestamp of the one or more interactions or activities recorded by the block 125. The data stored in each block 125 depends on the type of blockchain 124. For example, the data included in a block 125 may include information relating to the data interaction recorded by the block 125 including transmitting/receiving data, details of the data files, a copy of data received or generated as part of the interaction, identities of the sending and receiving nodes involved in the interaction etc. A hash of a block 125 is like a fingerprint that uniquely identifies the block 125 (and the interaction or activity recorded by the block 125) within the blockchain 124. Each hash of a block 125 is generated based on a cryptographic hash algorithm.

A computing node 104 of a computing infrastructure 102 often needs to access and download data stored at other computing nodes 104 of the computing infrastructure 102 to provide a requested service. For example, a first processing server that is configured to generate employee reports upon request of a user 106 may need to access employee data records stored at one or more other data servers. In conventional systems, consumption of data across computing nodes 104 of a computing network is often associated with several inefficiencies. For example, in conventional systems transfer of data resources across computing nodes 104 of a computing infrastructure 102 causes unnecessary data redundancy where multiple computing nodes 104 end up storing the same data. For example, regional employee data records of an organization's employees are typically stored in respective regional data servers that are physically located in respective regions. For example, employee records of employees located in the USA are stored in database servers that are physically located in the USA and employee records of employees located in Japan are stored in database servers that are physically located in Japan. Thus, a processing server configured to generate employee reports relating to employees located in a particular region needs to access and download regional employee records from a database server location in that particular region.

Several delays are generally associated with accessing and downloading data from a computing node. In one example, accessing a data server may involve lengthy authentication and authorization procedures that add delays in procuring the required data from the data server. For example, enhanced authentication and authorization procedures may be implemented for data transfers across regions (e.g., across countries) that may cause delays in accessing data across regions. Further, network latencies due to computing nodes located in different locations/regions may introduce delays in procuring the required data. The primary factor influencing network latency associated with a data transfer is the physical distance data packets need to travel between a transmitting node and a receiving node. This means that the further apart the transmitting and receiving nodes are, the longer it takes for data to travel between them, resulting in increased network delay or latency. For example, when the accessing server that is configured to generate employee reports is in New York and the database server storing employee records needed to generate a report is in Tokyo, the data packets have a longer journey compared to if both were in the same city.

In conventional systems, computing nodes usually download and store data locally (e.g., storing data in a data server located in the same city or state) to avoid lengthy access procedures and network delays. For example, regional employee data records may be downloaded from the respective regional database servers and stored at a data server that is geographically located in the same city as the processing server configured to generate employee reports. However, when multiple computing nodes download the same piece of data from a regional server, this leads to data redundancy where the same data is stored at several computing nodes. This data redundancy leads to wastage of data storage resources that can otherwise be used to store other data. Additionally, storage of sensitive data at multiple computing nodes lowers data security. For example, storing sensitive data at multiple servers can lower data security because it increases the potential attack surface, making it more difficult to manage access controls and monitor activity across all locations, which can lead to vulnerabilities where a breach could occur if proper security measures aren't implemented on each server, especially if the data isn't adequately encrypted across all locations.

Another inefficiency associated with accessing and transferring data across computing nodes of a computing infrastructure in conventional systems includes lengthy data scanning and retrieval leading to decreased computing performance and decreased network performance. For example, in conventional systems, a computing node does not know which computing nodes store what data. Thus, a computing node generally spends large amounts of computing and network resources to scan other computing nodes to determine a particular computing node that stores a requested piece of data. For example, large amounts of computing and network resources may need to be employed to scan all data servers of a particular region for a requested piece of data. This problem is more severe in a large computing infrastructure with thousands of computing nodes connected in a network and can severely compromise performance of computing nodes and the network.

Another inefficiency associated with accessing and transferring data across computing nodes of a computing infrastructure in conventional systems includes underutilization of memory resources due to data redundancy. As described above, in conventional systems, multiple computing nodes may locally store the same piece of data to avoid lengthy access procedures and network delays. For example, multiple processing servers, each configured to generate employee reports, may download employee data records relating to employees located in Japan from a regional database server located in Tokyo. However, it has been seen that most computing nodes rarely use most locally stored pieces of data leading to underutilization of memory resources thus resulting in wastage of memory resources. For example, a processing server configured to generate employee reports may be configured or requested to generate an employee report relating to Japanese employees on a quarterly basis, which means that the employee records relating to the Japanese employees stored locally at the processing server is only used once in three months.

Embodiments of the present disclosure describe improved techniques to make required data available to computing nodes while avoiding the inefficiencies of the conventional systems described above. For example, as described in accordance with embodiments of the present disclosure, the disclosed techniques include using AI algorithms to quickly determine a computing node of a computing infrastructure 102 that stores a requested piece of data and transfer the requested piece of data from the determined computing node to a requesting computing node. As described in this disclosure, a person having ordinary skill in the art can appreciate that the disclosed techniques overcome the inefficiencies associated with conventional systems including unnecessary data redundancy, insufficient data security, high network latency, slow data retrieval, and underutilization of memory resources. By avoiding the inefficiencies associated with conventional systems, the disclosed system and method improve computing system performance and network performance.

At least a portion of the computing infrastructure 102 (e.g., one or more computing nodes 104) may implement a transfer manager 150 which may be configured to implement techniques for managing transfer of data between computing nodes 104 (e.g., requesting node 104-1 and selected node 104-2) of the computing infrastructure. The transfer manager 150 includes a processor 152, a memory 156, and a network interface 154. The transfer manager 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

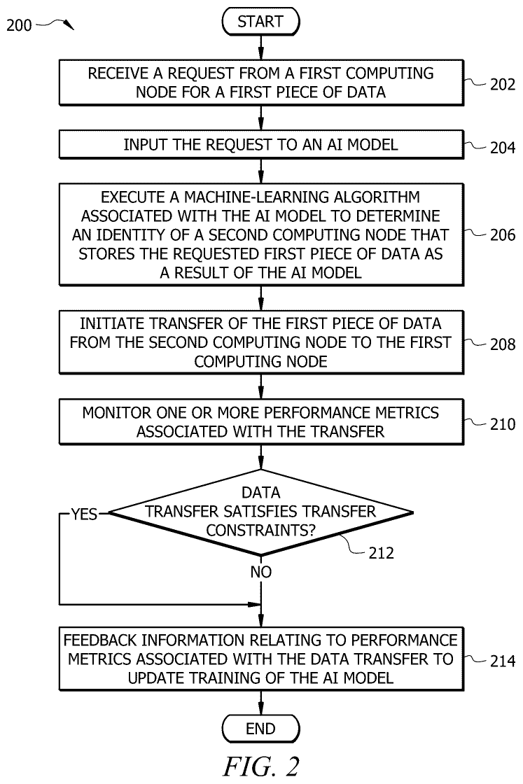

The one or more processors are configured to implement various instructions, such as software instructions. For example, the one or more processors are configured to execute instructions 158 to implement the transfer manager 150. In this way, processor 152 may be a special-purpose computer designed to implement the functions disclosed herein. In one or more embodiments, the transfer manager 150 is implemented using logic units, FPGAs, ASICs, DSPs, or any other suitable hardware. The transfer manager 150 is configured to operate as described with reference to FIGS. 1 and 2. For example, the processor 152 may be configured to perform at least a portion of method 200 as described with reference to FIG. 2 respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, data requests 160 initiated by computing nodes 104 including information relating to requested pieces of data 162, an artificial intelligence (AI) model 164 including a knowledge graph 176 and data transfer constraints 168, data transfer protocols 170 and performance metrics 172 associated with performance of data transfers between computing nodes 104, and any other data needed to performed operations of the transfer manager 150 as described in embodiments of the present disclosure. The instructions 158 may include any suitable set of instructions, logic, rules, or code operable to execute the transfer manager 150.

The network interface 154 is configured to enable wired and/or wireless communications. The network interface 154 is configured to communicate data between the transfer manager 150 and other devices, systems, or domains (e.g., computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 may be implemented like the transfer manager 150 shown in FIG. 1. For example, each of the computing nodes 104 may have a respective processor and a memory that stores data and instructions to perform a respective functionality of the computing node 104.

In one or more embodiments, the transfer manager 150 may be configured to determine a suitable computing node 104 (e.g., selected node 104-2) that stores a requested piece of data such that accessing and transferring the requested piece of data to a requesting computing node 104 (e.g., requesting node 104-1) satisfies one or more predefined data transfer constraints 168. The transfer manager 150 may be configured to use an AI model 164 to search for and determine a suitable computing node 104 (e.g., selected node 104-2) that stores a requested piece of data. In one embodiment, the AI model 164 is trained using a knowledge graph 166 associated with the computing infrastructure and one or more data transfer constraints 168. In one embodiment, the processor 152 of the transfer manager 150 is configured to execute a machine-learning algorithm 165 associated with the AI model 164 to implement the functionality of the AI model in embodiments of the present disclosure.

A knowledge graph (e.g., knowledge graph 166) is a structured way of representing real-world entities and their relationships, visualized as a network where logical “nodes” represent entities like devices, people, places, or concepts, and “edges” represent the connections between them, allowing for complex queries and analysis of how different pieces of information are related to each other. Essentially, a knowledge graph is a database that organizes information in a way that enables machines (e.g., machine learning/AI model) to better interpret and connect data across different sources. Knowledge graphs typically provide context and depth to AI techniques, such as machine learning, by organizing data from multiple sources and connecting entities like devices, people, places, or events, allowing AI models to solve complex problems. A typical knowledge graph includes at least three elements including logical nodes, edges, and labels. A “logical node” represents a real-world entity such as a device, data, people, places, concepts etc. An “edge” represents a logical connection between two logical nodes. A “label” represents a relationship between two logical nodes.

In the context of the present disclosure, knowledge graph 166 represents a plurality of computing nodes 104 of the computing infrastructure 102 and data stored at each of the computing nodes 104 as logical nodes and relationships between the logical nodes. For example, a first logical node of the knowledge graph 166 may represent a first computing node 104 and a second logical node of the knowledge graph 166 may represent a first piece of data stored at the first computing node 104. An edge of the knowledge graph 166 may connect the first and second logical nodes with a label associated with the edge indicating the relationship between the first and second logical nodes, the relationship being that the first computing node 104 represented by the first logical node stores the first piece of information represented by the second logical node. A plurality of logical nodes may represent the data stored at the first computing node 104, wherein each logical node, like the second logical node, represents a particular piece of data. Each logical node that represents a piece of data stored at the first computing node 104 may be connected using a respective edge to the first logical node that represents the first computing node 104. In other words, a network of logical nodes and relationships between the logical nodes represent data stored at the first computing node. Similarly, the knowledge graph 166 may represent data stored at other computing nodes 104 of the computing infrastructure 102 using logical nodes and relationships between the logical nodes.

In one or more embodiments, the transfer manager 150 may be configured to generate the knowledge graph 166. For example, the transfer manager 150 may first collect information relating to a plurality of computing nodes 104 of the computing infrastructure 102 that are configured to share data with other computing nodes 104 and information relating to data stored at each of the computing nodes 104. Information relating to a computing node 104 may include, but is not limited to, a device identity (ID) of the computing node 104, an Internet Protocol (IP) address of the computing node 104, a physical address of the computing node 104, real-time performance metrics (e.g., processing speed, CPU usage, memory usage, network bandwidth, average response time etc.) indicating performance of the computing node 104, and information relating to data stored at the computing node 104. Information relating to data stored at the computing node 104 may include, but is not limited to, particular pieces of data stored at the computing node such as data files, software packages, configuration files, and other static web content such as java scripts, HTML files etc.

Once information relating to the computing nodes 104 and data stored at each of the computing nodes 104 has been collected, the transfer manager 150 generates the knowledge graph 166 including generating a logical node for each computing node 104 and each piece of data (e.g., data file, software package, configuration file etc.) stored at each of the computing nodes 104. The transfer manager 150 connects the logical nodes using edges and assigns a label to each edge/connection indicating a relationship between logical nodes connected by the edge/connection. For example, a first logical node representing a first computing node 104 is connected to a second logical node representing a particular database file stored at the first computing node 104 and a label is assigned to this connection indicating that the first computing node 104 stores the particular database file. In one embodiment, additional attributes or properties may be associated with each logical node of the knowledge graph 166, wherein each attribute associated with a logical node provides information associated with the logical node. For example, attributes associated with a logical node that represents a computing node 104 may include, but are not limited to, a device identity (ID) of the computing node, an Internet Protocol (IP) address of the computing node, a physical address of the computing node, and real-time performance metrics such as processing speed, CPU usage, memory usage, network bandwidth and average response time. Attributes associated with a logical node that represents a piece of data stored at a computing node 104 may include, but are not limited to, data file name/ID, the type of data, size of data, file permissions, version, and ownership.

In one embodiment, the transfer manager 150 may be configured to update the knowledge graph 166 based on a pre-configured schedule (e.g., periodically) and/or upon request. For example, the transfer manager 150 may periodically scan the computing infrastructure 102 for newly added computing nodes (e.g., new computing node 104-4), data stored at the newly added computing nodes, dropped computing nodes, and changes to data stored at existing computing nodes. When a newly added computing node 104 (e.g., new computing node 104-4) is found, the transfer manager 150 may generate add new logical nodes and relationships in the knowledge graph 166 to represent the newly added computing node 104 and data stored at the newly added computing node 104. When a computing node 104 is no more found to be connected to the network 190, the transfer manager 150 may delete the logical nodes of the knowledge graph 166 that represent that the disconnected computing node 104 and data stored at the disconnected computing node 104. Upon detecting that data stored at a particular computing node 104 has been changed, the transfer manager 150 may update the knowledge graph 166 to add new logical nodes representing newly added data and delete existing logical nodes that represent data no more stored at the computing node 104. Additionally, or alternatively, at each scan event, the transfer manager 150 collects real time performance metrics associated with each computing node 104 and updates the respective attributes associated with the logical nodes that represent the computing nodes 104 so that the attributes indicate most recent performance metrics of the computing nodes 104.

The predefined data transfer constraints 168 define desired performance metrics that a computing node 104 selected by the AI model 164 is to adhere to. The data transfer constraints 168 may include, but are not limited to, a maximum network latency associated with transfer for data from a selected computing node 104 to a requesting computing node 104, a minimum CPU performance associated with the selected computing node 104, a minimum response time associated with the selected computing node 104, and a minimum network bandwidth available to the selected computing node 104. In one embodiment, the AI model 164 may be configured to search the knowledge graph 166 for a computing node 104 that stores a particular piece of data and satisfies one or more pre-defined data transfer constraints 168. For example, the transfer manager 150 may be configured to train the AI model 164 based on the knowledge graph 166 associated with the computing infrastructure 102 and the one or more predefined data transfer constraints 168.

In one or more embodiments, the transfer manager 150 may be configured to update the training of the AI model 164 based on the most recently updated knowledge graph 166 representing the most recent state of the computing nodes 104 and the data stored at the computing nodes 104. For example, as described above, the transfer manager 150 may be configured to update the knowledge graph 166 based on a pre-configured schedule (e.g., periodically) and/or upon request to generate updated knowledge graphs 166. The transfer manager 150 may be configured to re-train the AI model 164 periodically based on the updated knowledge graphs 166. In one embodiment, updating the training of the AI model 164 based on the most recent knowledge graphs 166 allows the AI model 164 to consider the most recent state of the computing nodes 104 and data stored at the computing nodes 104 and further consider the most recent performance metrics associated with the computing nodes 104 when selecting a suitable computing node 104 that satisfies one or more predefined data transfer constraints 168.

The transfer manager 150 may be configured to receive data requests 160 from computing nodes 104 (e.g., requesting node 104-1), wherein the data requests 160 include information relating to requested data 162. Requested data 162 included in a data request 160 indicates a particular piece of data such as data file, software package, configuration file etc. For example, a first computing node 104 (e.g., requesting node 104-1) may receive a request from a user 106 to generate an employee report relating to employees located in Japan. In response, the first computing node 104 may determine what particular database files the first computing node 104 needs to generate the requested report and may generate and transmit to the transfer manager 150 a data request 160 including requested data 162 indicating the particular database files.

In response to receiving a data request 160 from a requesting computing node 104, the transfer manager 150 may be configured to input the data request 160 or at least the requested data 162 included in the data request 160 to the AI model 164. The trained AI model 164 searches and analyzes the knowledge graph 166 for a computing node 104 that stores the requested data 162 such that a transfer of the requested data 162 from the computing node 104 to the requesting computing node 104 satisfies one or more predefined data transfer constraints 168. For example, when a data transfer constraint 168 defines a maximum network latency associated with transferring the requested data 162 from a computing node 104 to the requesting computing node 104, the AI model 164 selects a computing node 104 (e.g., selected node 104-2) that stores the requested data 162 and wherein an estimated network latency associated with transferring the requested data 162 from the selected computing node 104 (e.g., selected node 104-2) to the requesting computing node 104 equals or is lower than the maximum network latency. For example, upon detecting from the knowledge graph 166 that multiple computing nodes 104 store the requested data 162, the AI model 164 may estimate network latencies associated with transferring the requested data 162 from each of the computing nodes 104 to the requesting computing node 104. The AI model may then select a computing node 104 (e.g., selected node 104-2) associated with an estimated network latency that equals or is lower than the predefined maximum network latency. An identity (e.g., device ID, IP address etc.) of the selected computing node 104 is then output by the AI model 164. Upon obtaining a selected computing node 104 (e.g., selected node 104-2) as a result of the AI model 164, the transfer manager 150 may be configured to initiate transfer of the requested data 162 from the selected computing node 104 (e.g., selected node 104-2) to the requesting computing node 104 (e.g., requesting node 104-1).

In one or more embodiments, the transfer manager 150 may use smart contract technology to implement transfer of data between computing nodes 104 of the computing infrastructure 102. For example, data transfers may be performed between computing nodes 104 in accordance with smart contracts 126. A smart contract 126 is a software application or a piece of software code that represents an agreement between two users 106 or two computing nodes 104. A data interaction (e.g., transfer of data objects between two computing nodes 104) is generally processed when the conditions in the smart contract 126 are met. Smart contracts 126 are stored in the blockchain 124 and can be freely accessed and reviewed by all users 106 of the blockchain. Once created and stored in the blockchain 124, a smart contract 126 generally cannot be modified. Data interactions performed in accordance with a smart contract 126 are processed by the blockchain (e.g., one or more computing nodes 104) without a third party. Smart contracts 126 make it possible to securely automate and decentralize any data interaction associated with the blockchain network 120 no matter how complex. Thus, smart contracts 126 allow users 106 and/or computing nodes 104 of the blockchain network 120 to securely engage in complex data interactions without a trusted third party needing to administer these data interactions.

In the context of the present disclosure, the transfer manager 150 may generate a smart contract 126 to implement a transfer of requested data 162 between a computing node 104 selected by the AI model 164 and a requesting computing node 104. The smart contract 126 may include a plurality of data transfer rules 128 (or conditions), wherein the data transfer is processed/performed when the data transfer rules 128 are satisfied. The data transfer rules 128 may include, but are not limited to, identities of the transmitting computing node (e.g., selected by the AI model 164) and receiving computing node, access credentials associated with accessing data from the transmitting computing node, information relating to data (e.g., requested data 162) that is to be transferred from the transmitting computing node, and a data transfer protocol that is to be used for the data transfer. The transfer manager 150 may initiate transfer of the requested data 162 from the selected computing node 104 to the requesting computing node 104 by executing the smart contract 126 generated for this data transfer. As smart contracts 126, once created, cannot be modified, using smart contracts 126 to implement data transfers within the computing infrastructure 102 avoids bad actors from tampering with the data transfer rules 128 associated with the data transfers, thus improving data security associated with the data transfers. In one embodiment, the transfer manager 150 is configured to implement a data transfer between two computing nodes 104 using a peer-to-peer protocol such as HTTP/2 and WebRTC. For example, the transfer manager 150 may establish a peer-to-peer connection (e.g., P2P connections 110a, 110b) between a requesting computing node (e.g., requesting node 104-1) and a computing node (e.g., selected node 104-2) selected by the AI model 164.

In one or more embodiments, once the data transfer is initiated, the transfer manager 150 may be configured to monitor one or more real time performance metrics 172 associated with the actual transfer of the requested data from the selected computing node 104 to the requesting computing node 104 and determine whether one or more predefined data transfer constraints 168 are satisfied by the data transfer. In other words, the transfer manager 150 determines whether the actual transfer of data from the selected computing node 104 to the requesting computing node 104 satisfies the predefined data transfer constraints 168. The real time performance metrics 172 monitored by the transfer manager 150 may include, but are not limited to, network latency associated with the data transfer, CPU performance associated with the selected computing node 104, response time associated with the selected computing node 104, and network bandwidth available to the selected computing node 104. The transfer manager 150 may be configured to determine whether the data transfer from the selected computing node 104 to the requesting computing node 104 satisfies the predefined data transfer constraints 168 by comparing each predefined data transfer constraint 168 with a corresponding performance metric 172. For example, a predefined maximum network latency is compared with the real time network latency of the data transfer. In another example, a predefined minimum CPU response time of the selected computing node 104 is compared with the real time CPU response time of the selected computing node 104 as the data transfer is taking place.

For example, when a data transfer constraint 168 defines a maximum network latency to be conformed to by the actual data transfer, the transfer manager 150 collects real time data relating to network latency associated with the actual data transfer from the selected computing node 104 to the requesting computing node 104. The transfer manager 150 then compares the real time network latency with the predefined maximum network latency to determine whether the real time network latency satisfies the maximum network latency. When the real time network latency equals or is lower than the predefined maximum network latency, the transfer manager 150 determines that the actual data transfer satisfies the predefined maximum network latency.

In another example, when a data transfer constraint 168 defines a minimum CPU response time associated with the selected computing node 104 to be conformed to during the actual data transfer, the transfer manager 150 collects real time data relating to CPU response time of the selected computing node while the actual data transfer occurs. The transfer manager 150 then compares the real time CPU response time with the predefined minimum CPU response time to determine whether the real time CPU response time satisfies the predefined minimum CPU response time. When the CPU response time equals or is higher than the predefined minimum CPU response time, the transfer manager 150 determines that the actual data transfer satisfies the predefined minimum CPU response time.

In one or more embodiments, the transfer manager 150 may be configured to fine tune/update the training of the AI model 164 in response to determining that the actual data transfer does not satisfy a predefined data transfer constraint 168. For example, in response to determining that a value of a real time performance metric 172 associated with the actual data transfer does not conform to a corresponding data transfer constraint 168, the transfer manager 150 feeds back the real time value of the performance metric 172 to the AI model 164 to adjust/update the training of the AI model 164. This may cause the AI model 164 to consider the non-conformance of the particular data transfer constraint 168 when processing a subsequent data request 160 for the same piece of data (e.g., same requested data 162). This process of measuring and feeding back real time performance metrics of actual data transfer iteratively improves conformance of results generated by the AI model 164 to data transfer constraints 168.

For example, upon determining that the real time network latency of the actual data transfer is higher than the predefined maximum network latency, the transfer manager 150 determines that the actual data transfer does not satisfy the predefined maximum network latency. The value of the real time network latency is fed back to the AI model 164 and the AI model 164 is retrained based on this value of the real time network latency. Upon receiving a subsequent data request 160 for the same piece of data (e.g., same requested data 162), the AI model 164 may select another computing node 104 (e.g., alternate selected node 104-3) that is geographically closer to the requesting computing node 104 (e.g., requesting node 104-1) to lower the network latency of data transfer between the two computing nodes 104.

In one or more embodiments, the transfer manager 150 may be configured to store information relating to data transfers between computing nodes 104 of the computing infrastructure 102 in the blockchain 124 (e.g., as part of the blockchain ledger 122) associated with the blockchain network 120. For example, the transfer manager 150 may be configured to store in the blockchain 124 an interaction log associated with each data transfer that takes place between computing nodes 104 of the computing infrastructure 102, wherein an interaction log is a record of a data transfer. As data stored in a blockchain is immutable, meaning it cannot be altered or deleted once it's recorded, storing information relating to data transfers in the blockchain increases data security associated with the data transfers and avoids tampering with the data transfers by bad actors.

In one or more embodiments, the AI model 164 is configured to use a reinforcement learning (RL) algorithm 169. Reinforcement learning (RL) is a machine learning technique that teaches software how to make decisions to achieve the best outcome. It's a powerful tool for AI systems to achieve optimal outcomes in new environments. RL works by mimicking the trial-and-error process that humans use to learn. Software actions that help achieve a goal are reinforced, while actions that hinder the goal are ignored. RL algorithms use a reward-and-punishment paradigm to learn from the feedback of each action. For example, when the actual data transfer satisfies a data transfer constraint 168, it is considered as a reward. On the other hand, when the actual data transfer does not satisfy a data transfer constraint 168, it is considered as a punishment and the RL algorithm adjusts the training according to improve the selection of computing nodes 104 to improve conformance to the data transfer constraint 168.

FIG. 2 illustrates a flowchart of an example method for transferring data in a computing infrastructure, in accordance with one or more embodiments of the present disclosure. Method 200 may be performed by the transfer manager 150 shown in FIG. 1.

At operation 202, the transfer manager 150 receives a request (e.g., data request 160) from a first computing node 104 (e.g., requesting node 104-1) of a computing network (e.g., computing infrastructure 102) for a first piece of data (e.g., requested data 162).

As described above, the transfer manager 150 may be configured to receive data requests 160 from computing nodes 104, wherein the data requests 160 include information relating to requested data 162. Requested data 162 included in a data request 160 indicates a particular piece of data such as data file, software package, configuration file etc. For example, a first computing node 104 may receive a request from a user 106 to generate an employee report relating to employees located in Japan. In response, the first computing node 104 may determine what particular database files the first computing node 104 needs to generate the requested report and may generate and transmit to the transfer manager 150 a data request 160 including requested data 162 indicating the particular database files.

At operation 204, the transfer manager 150 inputs the data request 160 for the first piece of data (e.g., requested data 162) to the AI model 164.

At operation 206, the transfer manager 150 executes the machine-learning algorithm 165 associated with the AI model 164 to determine an identity of a second computing node 104 (e.g., selected node 104-2) that stores the requested first piece of data (e.g., requested data 162) as a result output by the AI model 164.

At operation 208, the transfer manager 150 initiates transfer of the first piece of data (e.g., requested data 162) from the second computing node 104 (e.g., selected node 104-2) to the first computing node 104 (e.g., requesting node 104-1).

As described above, in response to receiving a data request 160 from a requesting computing node 104, the transfer manager 150 may be configured to input the data request 160 or at least the requested data 162 included in the data request 160 to the AI model 164. The trained AI model 164 searches the knowledge graph 166 for a computing node 104 that stores the requested data 162 such that a transfer of the requested data 162 from the computing node 104 to the requesting computing node 104 satisfies one or more predefined data transfer constraints 168. For example, when a data transfer constraint 168 defines a maximum network latency associated with transferring the requested data 162 from a computing node 104 to the requesting computing node 104, the AI model 164 selects a computing node 104 that stores the requested data 162 and wherein an estimated network latency associated with transferring the requested data 162 from the selected computing node 104 to the requesting computing node 104 equals or is lower than the maximum network latency. For example, upon detecting from the knowledge graph 166 that multiple computing nodes 104 store the requested data 162, the AI model 164 may estimate network latencies associated with transferring the requested data 162 from each of the computing nodes 104 to the requesting computing node 104. The AI model may then select a computing node 104 associated with an estimated network latency that equals or is lower than the predefined maximum network latency. An identity (e.g., device ID, IP address etc.) of the selected computing node 104 is then output by the AI model 164. Upon obtaining a selected computing node 104 as a result of the AI model 164, the transfer manager 150 may be configured to initiate transfer of the requested data 162 from the selected computing node 104 to the requesting computing node 104.

At operation 210, the transfer manager 150 monitors one or more performance metrics 172 associated with the transfer of the first piece of data (e.g., requested data 162) from the second computing node 104 (e.g., selected node 104-2) to the first computing node 104 (e.g., requesting node 104-1).

At operation 212, the transfer manager 150 determines, based on the monitored one or more performance metrics 172, whether the data transfer satisfies one or more pre-defined data transfer constraints 168.

As described above, in one or more embodiments, once the data transfer is initiated, the transfer manager 150 may be configured to monitor one or more real time performance metrics 172 associated with the actual transfer of the requested data from the selected computing node 104 to the requesting computing node 104 and determine whether one or more predefined data transfer constraints 168 are satisfied by the data transfer. In other words, the transfer manager 150 determines whether the actual transfer of data from the selected computing node 104 to the requesting computing node 104 satisfies the predefined data transfer constraints 168. The real time performance metrics 172 monitored by the transfer manager 150 may include, but are not limited to, network latency associated with the data transfer, CPU performance associated with the selected computing node 104, response time associated with the selected computing node 104, and network bandwidth available to the selected computing node 104. The transfer manager 150 may be configured to determine whether the data transfer from the selected computing node 104 to the requesting computing node 104 satisfies the predefined data transfer constraints 168 by comparing each predefined data transfer constraint 168 with a corresponding performance metric 172. For example, a predefined maximum network latency is compared with the real time network latency of the data transfer. In another example, a predefined minimum CPU response time of the selected computing node 104 is compared with the real time CPU response time of the selected computing node 104 as the data transfer is taking place.

For example, when a data transfer constraint 168 defines a maximum network latency to be conformed to by the actual data transfer, the transfer manager 150 collects real time data relating to network latency associated with the actual data transfer from the selected computing node 104 to the requesting computing node 104. The transfer manager 150 then compares the real time network latency with the predefined maximum network latency to determine whether the real time network latency satisfies the maximum network latency. When the real time network latency equals or is lower than the predefined maximum network latency, the transfer manager 150 determines that the actual data transfer satisfies the predefined maximum network latency.

In another example, when a data transfer constraint 168 defines a minimum CPU response time associated with the selected computing node 104 to be conformed to during the actual data transfer, the transfer manager 150 collects real time data relating to CPU response time of the selected computing node while the actual data transfer occurs. The transfer manager 150 then compares the real time CPU response time with the predefined minimum CPU response time to determine whether the real time CPU response time satisfies the predefined minimum CPU response time. When the CPU response time equals or is higher than the predefined minimum CPU response time, the transfer manager 150 determines that the actual data transfer satisfies the predefined minimum CPU response time.

At operation 214, the transfer manager 150 inputs (e.g., feeds back) the recorded values of the performance metrics 172 related to the data transfer to the AI model 164 to update training of the AI model 164.

As described above, the transfer manager 150 may be configured to fine tune/update the training of the AI model 164 in response to determining that the actual data transfer does not satisfy a predefined data transfer constraint 168. For example, in response to determining that a value of a real time performance metric 172 associated with the actual data transfer does not conform to a corresponding data transfer constraint 168, the transfer manager 150 feeds back the real time value of the performance metric 172 to the AI model 164 to adjust/update the training of the AI model 164. This may cause the AI model 164 to consider the non-conformance of the particular data transfer constraint 168 when processing a subsequent data request 160 for the same piece of data (e.g., same requested data 162). This process of measuring and feeding back real time performance metrics of actual data transfer iteratively improves conformance of results generated by the AI model 164 to data transfer constraints 168.

In one or more embodiments, the AI model 164 is configured to use a reinforcement learning algorithm. Reinforcement learning (RL) is a machine learning technique that teaches software how to make decisions to achieve the best outcome. It's a powerful tool for AI systems to achieve optimal outcomes in new environments. RL works by mimicking the trial-and-error process that humans use to learn. Software actions that help achieve a goal are reinforced, while actions that hinder the goal are ignored. RL algorithms use a reward-and-punishment paradigm to learn from the feedback of each action. For example, when the actual data transfer satisfies a data transfer constraint 168, it is considered as a reward. On the other hand, when the actual data transfer does not satisfy a data transfer constraint 168, it is considered as a punishment and the RL algorithm adjusts the training according to improve the selection of computing nodes 104 to improve conformance to the data transfer constraint 168.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory storing an Artificial Intelligence (AI) model; and
a processor communicatively coupled to the memory and configured to:
receive a request from a first computing node of a computing network for a first piece of data;
input the request for the first piece of data to the AI model, wherein:
the AI model is trained using a knowledge graph and one or more data transfer constraints to determine a second computing node of the computing network that stores the requested first piece of data;
the knowledge graph at least represents a plurality of computing nodes of the computing network and data stored at each of the computing nodes as logical nodes and relationships between the logical nodes;
the AI model is trained to determine based on the knowledge graph the second computing node that satisfies the one or more data transfer constraints; and
the one or more data transfer constraints at least comprises a maximum network latency associated with transfer of data between the first computing node and the second computing node;
execute a machine-learning algorithm associated with the AI model to:
determine an identity of the second computing node that stores the requested first piece of data as a result output by the AI model; and
initiate transfer of the first piece of data from the second computing node to the first computing node.

2. The system of claim 1, wherein the processor is further configured to:
monitor the one or more data transfer constraints associated with the transfer of the first piece of data from the second computing node to the first computing node;
determine, based on the monitoring, that the transfer does not satisfy a first data transfer constraint of the one or more data transfer constraints;
input to the AI model a value of the first data transfer constraint associated with the transfer; and
update training of the AI model based on the value of the first data transfer constraint associated with the transfer to generate an updated AI model;
wherein the updated AI model is configured to determine a third computing node of the computing network that stores the requested first piece of data to improve conformance to the first data transfer constraint associated with transfer of the first piece of data from the third computing node to the first computing node.

3. The system of claim 1, wherein the processor is further configured to:
monitor network latency associated with the transfer of the first piece of data from the second computing node to the first computing node;
determine, based on the monitoring, that the network latency associated with the transfer is higher than the maximum network latency;
input to the AI model a value of the network latency associated with the transfer; and
update training of the AI model based on the value of the network latency associated with the transfer to generate an update AI model;
wherein the AI model is configured to determine a third computing node of the computing network that stores the requested first piece of data to improve the network latency associated with the transfer of the first piece of data from the third computing node to the first computing node.

4. The system of claim 1, wherein the processor is further configured to:
detect that a new computing node has been added to the computing network;
obtain information associated with data stored at the new computing node;
update the knowledge graph by adding the computing node and the data stored at the new computing node to generate an updated knowledge graph; and
update training of the AI model based on the updated knowledge graph.

5. The system of claim 1, wherein the processor is further configured to:
establish a peer-to-peer connection between the first computing node and the second computing node, wherein the first piece of data is transmitted from the second computing node to the first computing node over the peer-to-peer connection.

6. The system of claim 1, wherein the AI model uses a reinforcement learning algorithm to analyze the knowledge graph and determine the second computing node of the computing network that stores the requested first piece of data.

7. The system of claim 1, wherein information relating to the transfer of the first piece of data from the second computing node to the first computing node is stored in a blockchain associated with a blockchain network.

8. A method comprising:
receiving a request from a first computing node of a computing network for a first piece of data;
inputting the request for the first piece of data to an Artificial Intelligence (AI) model, wherein:
the AI model is trained using a knowledge graph and one or more data transfer constraints to determine a second computing node of the computing network that stores the requested first piece of data;
the knowledge graph at least represents a plurality of computing nodes of the computing network and data stored at each of the computing nodes as logical nodes and relationships between the logical nodes;
the AI model is trained to determine based on the knowledge graph the second computing node that satisfies the one or more data transfer constraints; and
the one or more data transfer constraints at least comprises a maximum network latency associated with transfer of data between the first computing node and the second computing node;
executing a machine-learning algorithm associated with the AI model to determine an identity of the second computing node that stores the requested first piece of data as a result output by the AI model; and
initiating transfer of the first piece of data from the second computing node to the first computing node.

9. The method of claim 8, further comprising:
monitoring the one or more data transfer constraints associated with the transfer of the first piece of data from the second computing node to the first computing node;
determining, based on the monitoring, that the transfer does not satisfy a first data transfer constraint of the one or more data transfer constraints;
inputting to the AI model a value of the first data transfer constraint associated with the transfer; and
updating training of the AI model based on the value of the first data transfer constraint associated with the transfer to generate an updated AI model;
wherein the updated AI model is configured to determine a third computing node of the computing network that stores the requested first piece of data to improve conformance to the first data transfer constraint associated with transfer of the first piece of data from the third computing node to the first computing node.

10. The method of claim 8, further comprising:
monitoring network latency associated with the transfer of the first piece of data from the second computing node to the first computing node;
determining, based on the monitoring, that the network latency associated with the transfer is higher than the maximum network latency;
inputting to the AI model a value of the network latency associated with the transfer; and
updating training of the AI model based on the value of the network latency associated with the transfer to generate an update AI model;
wherein the AI model is configured to determine a third computing node of the computing network that stores the requested first piece of data to improve the network latency associated with the transfer of the first piece of data from the third computing node to the first computing node.

11. The method of claim 8, further comprising:
detecting that a new computing node has been added to the computing network;
obtaining information associated with data stored at the new computing node;
updating the knowledge graph by adding the computing node and the data stored at the new computing node to generate an updated knowledge graph; and
updating training of the AI model based on the updated knowledge graph.

12. The method of claim 8, further comprising:
establishing a peer-to-peer connection between the first computing node and the second computing node, wherein the first piece of data is transmitted from the second computing node to the first computing node over the peer-to-peer connection.

13. The method of claim 8, wherein the AI model uses a reinforcement learning algorithm to analyze the knowledge graph and determine the second computing node of the computing network that stores the requested first piece of data.

14. The method of claim 8, wherein information relating to the transfer of the first piece of data from the second computing node to the first computing node is stored in a blockchain associated with a blockchain network.

15. A non-transitory computer-readable medium storing instructions that when executed by a processor causes the processor to:
receive a request from a first computing node of a computing network for a first piece of data;
input the request for the first piece of data to an Artificial Intelligence (AI) model, wherein:
the AI model is trained using a knowledge graph and one or more data transfer constraints to determine a second computing node of the computing network that stores the requested first piece of data;
the knowledge graph at least represents a plurality of computing nodes of the computing network and data stored at each of the computing nodes as logical nodes and relationships between the logical nodes;
the AI model is trained to determine based on the knowledge graph the second computing node that satisfies the one or more data transfer constraints; and
the one or more data transfer constraints at least comprises a maximum network latency associated with transfer of data between the first computing node and the second computing node;
execute a machine-learning algorithm associated with the AI model to determine an identity of the second computing node that stores the requested first piece of data as a result output by the AI model; and
initiate transfer of the first piece of data from the second computing node to the first computing node.

16. The non-transitory computer-readable medium of claim 15, wherein the instructions further cause the processor to:
monitor the one or more data transfer constraints associated with the transfer of the first piece of data from the second computing node to the first computing node;
determine, based on the monitoring, that the transfer does not satisfy a first data transfer constraint of the one or more data transfer constraints;
input to the AI model a value of the first data transfer constraint associated with the transfer; and
update training of the AI model based on the value of the first data transfer constraint associated with the transfer to generate an updated AI model;
wherein the updated AI model is configured to determine a third computing node of the computing network that stores the requested first piece of data to improve conformance to the first data transfer constraint associated with transfer of the first piece of data from the third computing node to the first computing node.

17. The non-transitory computer-readable medium of claim 15, wherein the instructions further cause the processor to:
monitor network latency associated with the transfer of the first piece of data from the second computing node to the first computing node;
determine, based on the monitoring, that the network latency associated with the transfer is higher than the maximum network latency;
input to the AI model a value of the network latency associated with the transfer; and
update training of the AI model based on the value of the network latency associated with the transfer to generate an update AI model;
wherein the AI model is configured to determine a third computing node of the computing network that stores the requested first piece of data to improve the network latency associated with the transfer of the first piece of data from the third computing node to the first computing node.

18. The non-transitory computer-readable medium of claim 15, wherein the instructions further cause the processor to:
detect that a new computing node has been added to the computing network;
obtain information associated with data stored at the new computing node;
update the knowledge graph by adding the computing node and the data stored at the new computing node to generate an updated knowledge graph; and
update training of the AI model based on the updated knowledge graph.

19. The non-transitory computer-readable medium of claim 15, wherein the instructions further cause the processor to:
establish a peer-to-peer connection between the first computing node and the second computing node, wherein the first piece of data is transmitted from the second computing node to the first computing node over the peer-to-peer connection.

20. The non-transitory computer-readable medium of claim 15, wherein the AI model uses a reinforcement learning algorithm to analyze the knowledge graph and determine the second computing node of the computing network that stores the requested first piece of data.
